(19) United States
(12) Patent Application Publication
(10) Pub. No.: US 2017/0280705 A1
(43) Pub. Date: Oct. 5, 2017

(54) SELF RESTORING DECOY

(71) Applicant: Gregory S. Burcham, Falkville, AL (US)

(72) Inventor: Gregory S. Burcham, Falkville, AL (US)

(73) Assignee: EBSCO Industries, Inc., Birmingham, AL (US)

(21) Appl. No.: 15/087,925

(22) Filed: Mar. 31, 2016

(51) Int. Cl. A01M 31/06; B29C 65/48; B29C 41/22; B29C 33/38; B29C 41/04

(52) U.S. Cl. CPC A01M 31/06; B29C 33/3842; B29C 41/04; B29C 41/22; B29C 65/48; B29K 2027/06

(57) ABSTRACT

A compressible decoy construction involves a thin rubber roto molded outer shell lined with a thicker layer of foam rubber. The interior of the decoy is hollow, thus allowing the decoy to be folded or compressed into a small mass such that when the compressive force is removed, the decoy returns to its full shape due to the memory of the foam rubber lining.

### FIELD OF INVENTION

This invention relates to hunting and decoys used in hunting. More specifically the invention relates to portable decoys that can be stowed for transport and then deployed by at hunter in the field. In even greater particularity, the invention relates to decoys that can be compressed for transport such that a number of decoys can be carried and then released from compression to return to their shape emulating a game animal or some other decoy. In still greater particularity, the present invention relates to compressible decoys that have a shape memory such that they return to the original shape once compression is released

### BACKGROUND

The use of decoys is well known in the hunting industry including hand carved wooden duck decoys, rigid deer decoys, inflatable turkey decoys and a myriad of other decoys that the hunter must transport to the field to try to provide the game animal with a sense of safety due to the presence of other similar animals. Of course, the hunter must transport these decoys to the field each time he wishes to use them and the bulk of some rigid or wooden decoys clearly limit the number of decoys that can be transported, even on an all- terrain vehicle. Inflatable decoys develop leaks and may not present a realistic look after several uses and may be too lightweight to remain in a non-threatening posture in the field. Consequently there is a need for a collapsible and re-deployable decoy that conserves space and presents a realistic appearance.

This invention embodies a new type of decoy used for turkey hunting. Its construction involves a thin rubber roto molded outer shell lined with a thicker layer of foam rubber. The interior of the decoy is hollow, thus allowing the decoy to be folded or compressed into a small mass. When the compressive force is removed, the decoy returns to its full shape due to the memory of the foam rubber lining.

### BRIEF DESCRIPTION OF THE DRAWINGS

Referring to the drawings which are appended hereto and which form a portion of this disclosure, it may be seen that:

FIG. 1 is perspective view of my improved decoy in the form of a turkey;

FIG. 2 is a sectional view of my improved decoy along a vertical axis;

FIG. 3 is bottom view of my improved decoy.

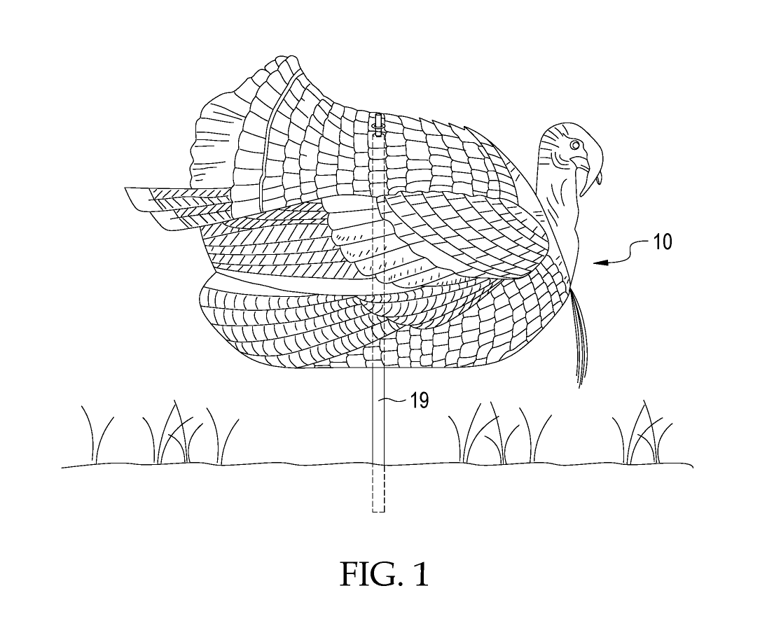

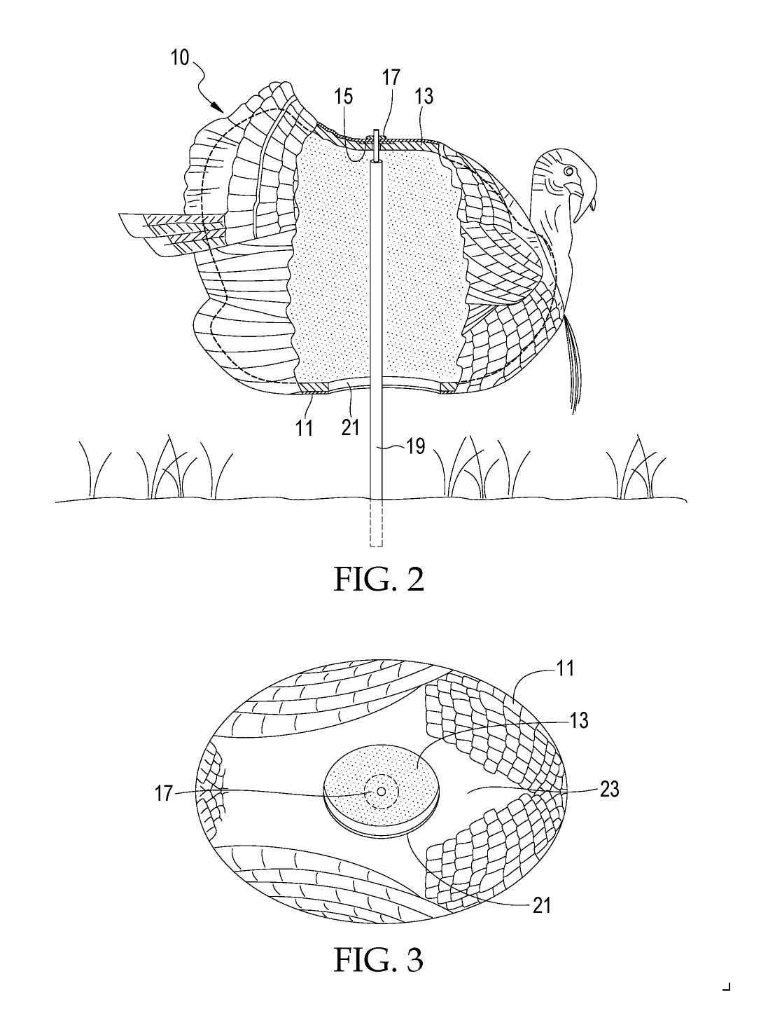

### DETAILED DESCRIPTION

One or more of the above objects can be achieved, at least in part, by providing a decoy 10 that does not require inflation but can be compressed to reduce volume. The preferred material for construction of the self-restoring decoy 10 are as follows: The decoy 10 includes an outer shell 11 which must be a rubberized material that can be roto- molded and will return to its original shape after being crushed or deformed due to an external force applied by the hunter. The shell is molded in the shape of a wild animal with detailed features of the wild animal molded thereon. Rotational Molding, also called roto- molding or roto-cast, is a thermoplastic process for producing hollow parts by placing powdered resin into a hollow mold and then rotating that mold bi-axially in an oven until the resin melts and coats the inside of the mold. Materials that may be used to fabricate the decoy shell 11 include Polyethylene including LLDPE, LDPE, HPPE, Cross-Linked or Recycled/Regrind; Polyvinyl chloride (PVC); Nylon; Polypropylene; and Thermoplastic Polyester Elastomers TPE. However, the outer shell 11 must be resilient, permeable and flexible as well as compatible with a rubberized paint such that the paint providing the proper coloration for the decoy does not flake or chip off when the decoy is rolled up or crushed. To the best of my knowledge, PVC rubber is the best choice as it can be roto-molded to capture extreme detail and also makes a chemical bond to a layer of flexible paint, thus eliminating chipping and peeling of the paint. Any roto-moldable rubber compound would work provided it possessed these qualities.

The Decoy also includes an inner layer 13 of open cell foam of polyethylene, polypropylene or poly styrene affixed to the inner surface of shell 11 from adjacent an opening 21 in a bottom portion 23 of shell 11 contiguous and coextensive with the inner surface, thus forming an inner hollow core which communicates with opening 21. However, the foam layer 13 must possess the following qualities: It must be compressible, thus open cell foam rubber such as those made of polyurethane is the best choice as the air can escape from the voids allowing it to be compressed to a minimum volume. Additionally, the decoy must return to its original shape and volume once compressive forces are removed. Closed cell foam entraps air bubbles and thus cannot be compressed to a minimum volume. There may be other materials that would meet this function, but for cost and availability, open cell foam rubber is the best choice.

As far as the manufacturing process goes, roto-molding is the best choice for the outer shell 11. Roto-molding allows the part to pick up fine details of the animal features that are a must have in today's high end decoy market and roto-moldable resins have superior paint adhesion. While the outer shell 11 could be blow molded, it would lack the necessary detail and would restrict material choices to extrude-able polymers. Further, extrude-able polymers that are flexible are notoriously difficult to paint or decorate due to their low surface tension.

Due to the low tensile strength of the decoy material, a small support plate made 15 of die cut plastic sheet with a grommet 17 must be mounted to the balance point of the inside surface of the decoy on a region corresponding to the back of the decoy animal such that the decoy balances in the proper posture when placed on a stake 19 for use in the field. In practice, a hunter would manually compress the decoy to the minimum size desired and secure the compressed decoy with a strap or compression sack for transport to the field. At the field, decoy would be released from compression and return to its normal shape. The restored decoy could then be placed on stake 19.

Once the outer layer 11 has been molded and the grommet 17 has been installed, there are two options for installing the foam rubber layer 13. One option is to roto-mold an expanding foam layer on the interior surface of the outer shell 11. This would allow the foam rubber to be bonded to the inner surface of the outer shell while maintaining a hollow core. However, roto-molded expanding foam would be difficult to control a consistent wall thickness. A second option, and probably the most affordable, is to install a fabricated foam rubber liner into the outer shell using an adhesive to secure the two layers. In either option, the outer shell is secured to the foam rubber layer via an access hole 21 cut into the underbelly or bottom portion 23 of the decoy 10.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A decoy in a shape of a wild animal, comprising:
a. A shell molded in a shape of said wild animal with detailed features of said wild animal molded thereon, said shell being resilient, permeable and flexible and having a bottom portion circumscribing an opening in said shell;
b. A layer of open cell foam affixed to an inner surface of said shell from adjacent said opening contiguous with the inner surface, said layer of open cell foam defining an inner hollow core of said decoy communicating with said opening in said shell; wherein said shell and said layer of open cell foam are compressible due to external force applied to said shell to reduce the volume of said decoy, wherein said shell and said layer of open cell foam returns to the shape of said wild animal upon release of said external force without any restoring force being applied.

2. A decoy as defined in claim 1 further comprising a support plate, with a grommet, mounted to a balance point of an inside surface of the decoy such that said decoy balances in proper posture when placed on a stake.

3. A decoy as defined in claim 2 further comprising a stake for insertion into said grommet to support said decoy.

4. A decoy as defined in claim 2 further comprising a layer of flexible paint applied to said shell on an exterior surface thereof to emulate the coloration of said wild animal.

5. A decoy as defined in claim 1 wherein said shell is comprises a poly vinyl chloride material.

6. A decoy as defined in claim 5 wherein said layer of open cell foam is bonded to said shell by a molding process.

7. A decoy as defined in claim 5 wherein said layer of open cell foam is affixed to said shell with a layer of adhesive.

8. A decoy as defined in claim 5 wherein said layer of open cell foam comprises a polyurethane material.

9. A decoy as defined in claim 3 further comprising a strap for applying said external force to said decoy and for securing said decoy in a compressed state for transport.

10. A method of fabricating a decoy in the shape of a wild animal, comprising:
a. Creating a mold for use in a roto molding process said mold designed to mirror the external features of said wild animal;
b. Roto-molding a thin flexible shell in the shape of said wild animal within said mold;
c. Forming an opening in a bottom portion of said then flexible shell;
d. Applying a thick layer of open cell foam inside said thin flexible shell; and,
e. Painting an outside surface of said shell with colors mimicking said wild animal.
